(19) United States
(12) Patent Application Publication
(10) Pub. No.: US 2025/0091465 A1
(43) Pub. Date: Mar. 20, 2025

(54) POWER DISTRIBUTION DEVICE

(71) Applicant: YAZAKI CORPORATION, Tokyo (JP)

(72) Inventors: Mitsuaki Morimoto, Susono-shi (JP); Kazuo Sugimura, Susono-shi (JP); Kazuhiro Koto, Susono-shi (JP)

(21) Appl. No.: 18/826,530

(22) Filed: Sep. 6, 2024

(30) Foreign Application Priority Data
Sep. 20, 2023 (JP) 2023-151880

(51) Int. Cl. B60L 53/62; B60L 50/60; H02J 7/00

(52) U.S. Cl. CPC B60L 53/62; B60L 50/66; H02J 7/0024; H02J 7/0036

(57) ABSTRACT

The power distribution device includes a first battery positive electrode terminal, a first battery negative electrode terminal, a second battery positive electrode terminal, a second battery negative electrode terminal, a charger positive electrode terminal, a charger negative electrode terminal, a first line, a second line, a third line, a first switch, a fourth line, a second switch, a fifth line, a third switch, and a control unit. The control unit is configured to control conductive states and interruption states of the first switch, the second switch, or the third switch and includes a voltage measurement unit, a current measurement unit, and a failure determination unit configured to determine a failure in the first switch, the second switch, or the third switch based on the voltage measured by the voltage measurement unit and the current measured by the current measurement unit.

### CROSS-REFERENCE TO RELATED APPLICATIONS

This application is based on and claims priority under 35 USC 119 from Japanese Patent Application No. 2023-151880 filed on Sep. 20, 2023.

### TECHNICAL FIELD

The present invention relates to a power distribution device.

### BACKGROUND ART

In recent years, in consideration of the environment, electric vehicles including high-voltage batteries, such as an electric vehicle (EV) and a plug-in hybrid electric vehicle (PHEV), have appeared. The voltage of these electric vehicles is increasing year by year, for example, from approximately 400 V to approximately 800 V. As the voltage of the electric vehicles increases, the rated voltage of chargers for the electric vehicles is also increasing, which can be compatible with a vehicle including a high-voltage battery. However, since a charger having a high specification requires a large amount of power, it is difficult to provide the charger in a region with a poor power condition, and it is difficult to replace all currently provided chargers with the charger that can be compatible with a voltage of, for example, 800 V.

Therefore, a power distribution device that allows switching between series connection and parallel connection of secondary batteries mounted on an electric vehicle has been proposed (for example, see Patent Literature 1). According to the power distribution device, by switching to the parallel connection at the time of charging, the voltage at the time of charging can be made lower than that in the case of series connection. Thus, the electric vehicle having a high voltage can be charged even with a low voltage.

### CITATION LIST

### Patent Literature

Patent Literature 1: JP2022-63722A

### SUMMARY OF INVENTION

However, in the power distribution device disclosed in Patent Literature 1, when a failure occurs in the switch for switching between the series connection and the parallel connection, a short circuit or like that occurs in the secondary battery, and the reliability decreases. In particular, when a plurality of switches are used, it is possible to further improve the reliability by identifying which switch has a failure.

Therefore, an object of the present invention is to provide a power distribution device capable of further improving the reliability.

In order to achieve the above-described object, the power distribution device regarding one of embodiments of the present disclosure includes a first battery positive electrode terminal and a first battery negative electrode terminal connected to a positive electrode and a negative electrode of a first battery respectively, a second battery positive electrode terminal and a second battery negative electrode terminal connected to a positive electrode and a negative electrode of a second battery respectively, a charger positive electrode terminal and a charger negative electrode terminal connected to a positive electrode and a negative electrode of a charger respectively, a first line connecting the first battery positive electrode terminal and the charger positive electrode terminal, a second line connecting the second battery negative electrode terminal and the charger negative electrode terminal, a third line connecting the second battery positive electrode terminal and the first battery negative electrode terminal, a first switch configured to control conduction and interruption of the third line, a fourth line connecting the second battery positive electrode terminal and the first line, a second switch configured to control conduction and interruption of the fourth line, a fifth line connecting the second line and the first battery negative electrode terminal, a third switch configured to control conduction and interruption of the fifth line; and a control unit configured to control conductive states and interruption states of the first switch, the second switch, or the third switch. The control unit includes a voltage measurement unit configured to measure a voltage of the first line and the second line, a current measurement unit configured to measure a current in one of the fourth line or the fifth line, and a failure determination unit configured to determine a failure in the first switch, the second switch, or the third switch based on the voltage measured by the voltage measurement unit and the current measured by the current measurement unit.

According to the present disclosure, it is possible to provide a power distribution device capable of further improving the reliability.

### BRIEF DESCRIPTION OF DRAWINGS

FIG. 1 is a diagram showing a secondary battery system including a power distribution device according to an embodiment of the present invention;

FIG. 2 is a first state diagram showing a control state attained by an SW control unit shown in FIG. 1;

FIG. 3 is a second state diagram showing a control state attained by the SW control unit shown in FIG. 1;

FIG. 4 is a first table showing a failure determination method executed by a failure determination unit shown in FIG. 1;

FIG. 5 is a second table showing the failure determination method executed by the failure determination unit shown in FIG. 1;

FIG. 6 is a first state diagram showing current flows in failure states;

FIG. 7 is a second state diagram showing the current flows in the failure states;

FIG. 8 is a third state diagram showing the current flows in the failure states;

FIG. 9 is a fourth state diagram showing the current flows in the failure states;

FIG. 10 is a fifth state diagram showing the current flows in the failure states;

FIG. 11 is a sixth state diagram showing the current flows in the failure states;

FIG. 12 is a seventh state diagram showing the current flows in the failure states;

FIG. 13 is an eighth state diagram showing the current flows in the failure states;

FIG. 14 is a configuration diagram showing a secondary battery system according to a first modification of the present embodiment; and

FIG. 15 is a configuration diagram showing a secondary battery system according to a second modification of the present embodiment.

### DESCRIPTION OF EMBODIMENTS

Hereinafter, the present invention will be described with reference to a preferred embodiment. The present invention is not limited to the embodiment to be described below, and the embodiment can be appropriately modified without departing from the gist of the present invention. In the embodiment to be described below, there may be portions in which illustration and description of a part of a configuration are omitted, and it is needless to say that a known or well-known technique is appropriately applied to the details of an omitted technique within a range in which no contradiction with the contents to be described below occurs.

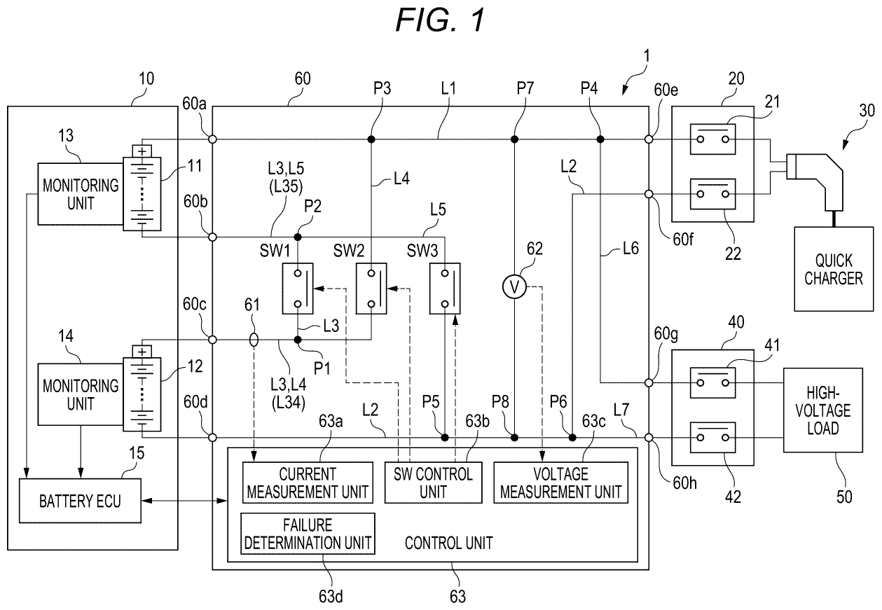

FIG. 1 is a configuration diagram showing a secondary battery system including a power distribution device according to an embodiment of the present invention. A secondary battery system 1 shown in FIG. 1 includes a high-voltage battery 10, a charging junction box (hereinafter referred to as J/B) 20, a quick charger (a charger) 30, a high-voltage J/B 40, a high-voltage load 50, and a power distribution device 60.

The high-voltage battery 10 includes a first battery 11, a second battery 12, a first monitoring unit 13, a second monitoring unit 14, and a battery electronic control unit (ECU) 15.

The first battery 11 and the second battery 12 are implemented by a rechargeable secondary battery such as a lithium ion battery. The first battery 11 and the second battery 12 are each capable of supplying a high voltage of, for example, 400 V in order to drive the high-voltage load 50 in an electric vehicle. In the present embodiment, the first battery 11 and the second battery 12 are assumed to have the same voltage.

The first monitoring unit 13 monitors the voltage, the current, and the temperature of the first battery 11. The second monitoring unit 14 monitors the voltage, the current, and the temperature of the second battery 12. The battery ECU 15 calculates the charging rates of the first battery 11 and the second battery 12 based on the information from the first monitoring unit 13 and the second monitoring unit 14. The battery ECU 15 may calculate the degree of deterioration of the first battery 11 and the second battery 12, detect an abnormality of the first battery 11 and the second battery 12, and the like.

The charging J/B 20 is a relay device interposed between the power distribution device 60 and the quick charger 30. The charging J/B 20 includes a first charging relay 21 and a second charging relay 22. The first charging relay 21 controls the connection between the positive electrode side of the quick charger 30 and the power distribution device 60. The second charging relay 22 controls the connection between the negative electrode side of the quick charger 30 and the power distribution device 60. The first charging relay 21 and the second charging relay 22 may be either of a mechanical contact type or a semiconductor type. The same applies to a first high-voltage relay 41, a second high-voltage relay 42, and a first switch SW1 to a third switch SW3 to be described later.

The quick charger 30 supplies power for charging the first battery 11 and the second battery 12 through the charging J/B 20 and the power distribution device 60. The quick charger may supply, for example, power having a voltage of 400 V or power having a voltage of 800 V. The power distribution device 60 determines whether the first battery 11 and the second battery 12 are to be in the series state or the parallel state according to the supplied power, and charges the first battery 11 and the second battery 12 in the connected state. The secondary battery system 1 according to the present embodiment is assumed to be charged by the quick charger 30, but is not particularly limited thereto, and may be charged by a general charger that is not quick.

The high-voltage J/B 40 is a relay device interposed between the power distribution device 60 and the high-voltage load 50. The high-voltage J/B 40 includes a first high-voltage relay 41 and a second high-voltage relay 42. The first high-voltage relay 41 controls the connection between the positive electrode side of the high-voltage load 50 and the power distribution device 60. The second high-voltage relay 42 controls the connection between the negative electrode side of the high-voltage load 50 and the power distribution device 60. The high-voltage load 50 is a motor or the like that generates a driving force for the vehicle.

The power distribution device 60 sets the connection state of the first battery 11 and the second battery 12 to the series state or the parallel state at the time of charging from the quick charger 30 through the charging J/B 20 or at the time of discharging to the high-voltage load 50 through the high-voltage J/B 40.

The power distribution device 60 includes a plurality of terminals 60a to 60h. The first battery positive electrode terminal 60a and the first battery negative electrode terminal 60b are terminals that are connected to the positive electrode and the negative electrode of the first battery 11, respectively. The second battery positive electrode terminal 60c and the second battery negative electrode terminal 60d are terminals that are connected to the positive electrode and the negative electrode of the second battery 12, respectively. The charger positive electrode terminal 60e and the charger negative electrode terminal 60f are terminals that are connected to the positive electrode and the negative electrode of the quick charger 30, respectively. The load positive electrode terminal 60g and the load negative electrode terminal 60h are terminals that are connected to the positive electrode and the negative electrode of the high-voltage load 50, respectively.

Further, the power distribution device 60 includes a plurality of lines L1 to L7, a plurality of switches SW1 to SW3, a current sensor 61, a voltage sensor 62, and a control unit 63.

The first line L1 connects the first battery positive electrode terminal 60a and the charger positive electrode terminal 60e. The second line L2 connects the second battery negative electrode terminal 60d and the charger negative electrode terminal 60f. The third line L3 connects the second battery positive electrode terminal 60c and the first battery negative electrode terminal 60b. As will be described later, one end side (from the terminal 60c to a connection point P1 in FIG. 1) of the third line L3 is shared with the fourth line L4, and the other end side (from the terminal 60b to a connection point P2 in FIG. 1) of the third line L3 is shared with the fifth line L5. The third line L3 connects the first battery negative electrode terminal 60b and the second battery positive electrode terminal 60c via common portions L34 and L35. The first switch SW1 controls conduction and interruption of the third line L3, and is provided at a position on the third line L3 excluding the common portions L34 and L35.

The fourth line L4 connects the second battery positive electrode terminal 60c and the first line L1. One end side of the fourth line L4 has the common portion L34 shared with the third line L3. The second switch SW2 controls conduction and interruption of the fourth line L4, and is provided at a position on the fourth line L4 excluding the common portion L34 shared with the third line L3.

The fifth line L5 connects the second line L2 and the first battery negative electrode terminal 60b. The other end side of the fifth line L5 has the common portion L35 shared with the third line L3. The third switch SW3 controls conduction and interruption of the fifth line L5, and is provided at a position on the fifth line L5 excluding the common portion L35 shared with the third line L3.

The sixth line L6 connects a connection point P4 of the first line L1, which is located on the charger positive electrode terminal 60e side with respect to a connection point P3 with the fourth line L4, to the load positive electrode terminal 60g. The seventh line L7 connects a connection point P6 of the second line L2, which is located on the charger negative electrode terminal 60f side with respect to a connection point P5 with the fifth line L5, to the load negative electrode terminal 60h.

The current sensor 61 is provided on the fourth line L4 and outputs a signal corresponding to the current on the fourth line L4. In the present embodiment, the current sensor 61 is provided in the common portion L34 of the fourth line L4 with the third line L3.

The voltage sensor 62 outputs a signal corresponding to a potential difference between the first line L1 and the second line L2. More specifically, the voltage sensor 62 outputs a signal corresponding to a potential difference between a connection point P7 located between the connection point P3 and the connection point P4 on the first line L1, and a connection point P8 located between the connection point P5 and the connection point P6 on the second line L2.

The control unit 63 controls the entire power distribution device 60, and includes a current measurement unit 63a, an SW control unit 63b, a voltage measurement unit 63c, and a failure determination unit 63d.

The current measurement unit 63a measures the current in the fourth line L4 (particularly, the common portion L34) according to the signal from the current sensor 61. The voltage measurement unit 63c measures a voltage corresponding to the potential difference between the first line L1 and the second line L2 according to the signal from the voltage sensor 62.

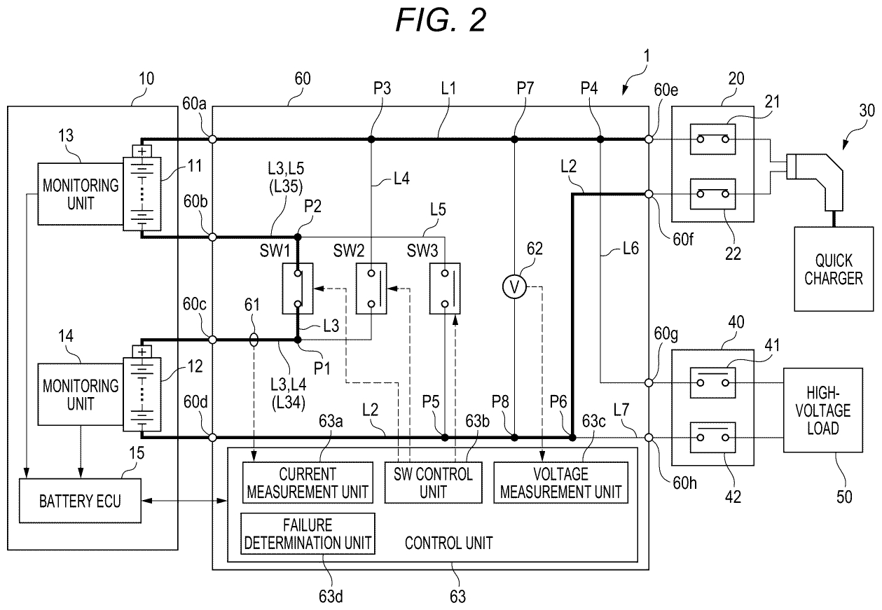

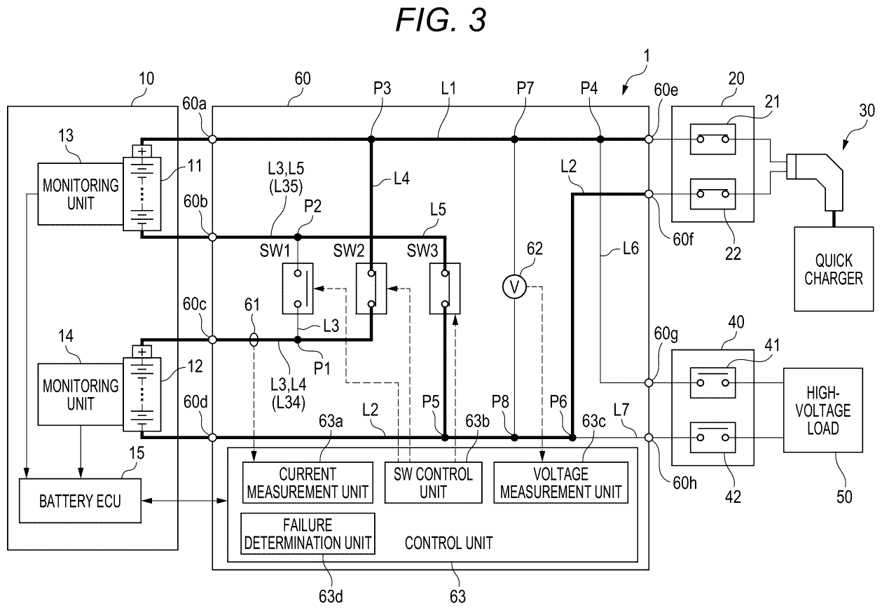

The SW control unit 63b controls the conduction state (ON) and the interruption state (OFF) of the first switch SW1, the second switch SW2, and the third switch SW3. FIGS. 2 and 3 are state diagrams showing control states attained by the SW control unit 63b shown in FIG. 1. First, as shown in FIG. 2, when it is desired to connect the first battery 11 and the second battery 12 in series, the SW control unit 63b turns on the first switch SW1 and turns off the second switch SW2 and the third switch SW3. Accordingly, for example, at the time of charging, a route (see a thick line) of the first line L1, the first battery 11, the third line L3, the second battery 12, and the second line L2 is formed. Thus, the first battery 11 and the second battery 12 are connected in series. On the other hand, as shown in FIG. 3, when it is desired to connect the first battery 11 and the second battery 12 in parallel, the SW control unit 63b turns off the first switch SW1 and turns on the second switch SW2 and the third switch SW3. Accordingly, at the time of charging, a route (see a thick line) of the first line L1, the first battery 11, the fifth line L5, and the second line L2 and a route (see a thick line) of the first line L1, the fourth line L4, the second battery 12, and the second line L2 are formed. Thus, the first battery 11 and the second battery 12 are connected in parallel.

The failure determination unit 63d determines a failure in the first switch SW1, the second switch SW2, and the third switch SW3. The failure determination unit 63d determines a failure in the first switch SW1, the second switch SW2, or the third switch SW3 based on the voltage measured by the voltage measurement unit 63c and the current measured by the current measurement unit 63a.

In one embodiment, the control unit includes a processor and a memory storing instructions that, when executed by the processor, cause the processor to:
measure the current in the fourth line L4 (particularly, the common portion L34) according to the signal from the current sensor 61,
measure a voltage corresponding to the potential difference between the first line L1 and the second line L2 according to the signal from the voltage sensor 62, and
determine a failure in the first switch SW1, the second switch SW2, or the third switch SW3 based on the voltage measured by the voltage measurement unit 63c and the current measured by the current measurement unit 63a.

In one embodiment, the control unit may be a control device such as an integrated circuit (IC) and an application specific integrated circuit (ASIC).

For example, an ON failure in which the first switch SW1, the second switch SW2, and the third switch SW3 are always on and an OFF failure in which the first switch SW1, the second switch SW2, and the third switch SW3 are always off may occur. When an ON failure or an OFF failure occurs in these switches SW1 to SW3, the location of the failure can be identified to some extent based on the voltage. However, for example, it may be difficult to determine which of the second switch SW2 or the third switch SW3 used at the time of parallel connection has a failure based only on the voltage. However, the power distribution device 60 according to the present embodiment can determine which of the second switch SW2 or the third switch SW3 has a failure by further measuring the current in one of the fourth line L4 and the fifth line L5.

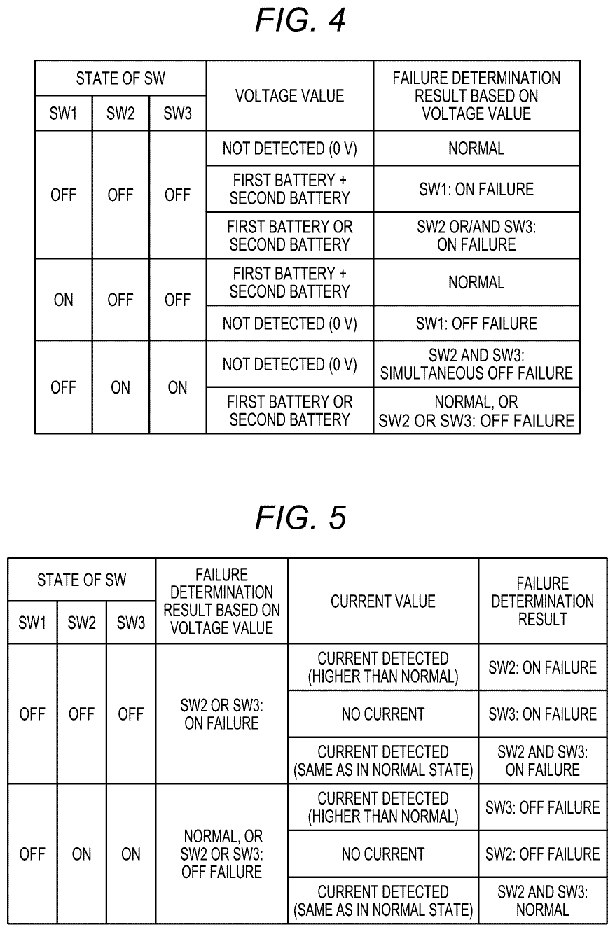

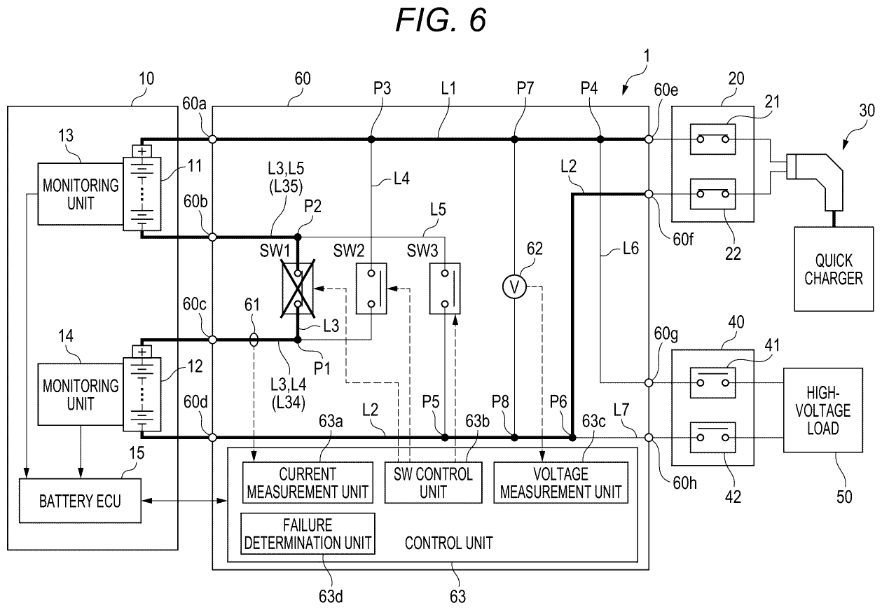

Hereinafter, a failure determination method executed by the failure determination unit 63d will be described in detail. FIGS. 4 and 5 are tables showing the failure determination method executed by the failure determination unit 63d shown in FIG. 1, and FIGS. 6 to 13 are state diagrams showing the current flows in the failure states.

First, as shown in FIG. 4, when neither charging from the quick charger 30 nor discharging to the high-voltage load 50 is performed, the SW control unit 63b turns off all of the switches SW1 to SW3 as shown in FIG. 1. Therefore, the voltage measurement unit 63c is to measure a voltage of 0 V. Accordingly, when 0 V is measured by the voltage measurement unit 63c, the failure determination unit 63d can determine that all of the first switch SW1, the second switch SW2, and the third switch SW3 are turned off and normal (see FIGS. 1 and 4). When the sum value of the voltage of the first battery 11 and the voltage of the second battery 12 is detected (for example, when 800 V is measured), the failure determination unit 63d can determine that the first switch SW1 has an ON failure (see FIGS. 4 and 6). However, in a case in which the voltage of the first battery 11 and the voltage of the second battery 12 are the same or the like, when either one of the voltages is detected (for example, when 400 V is measured), the failure determination unit 63d cannot identify the location of the failure. That is, in this case, the failure determination unit 63d can only determine that at least one of the second switch SW2 or the third switch SW3 has an ON failure.

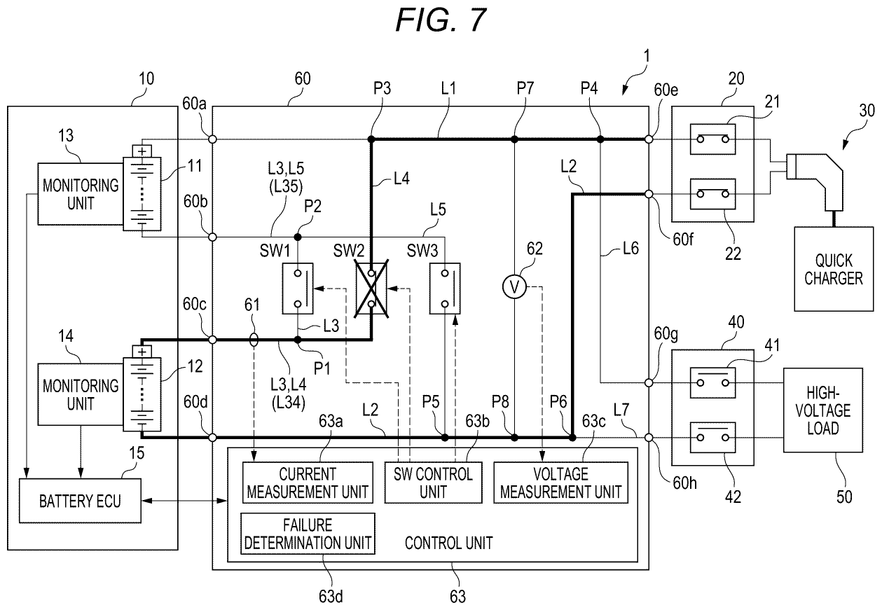

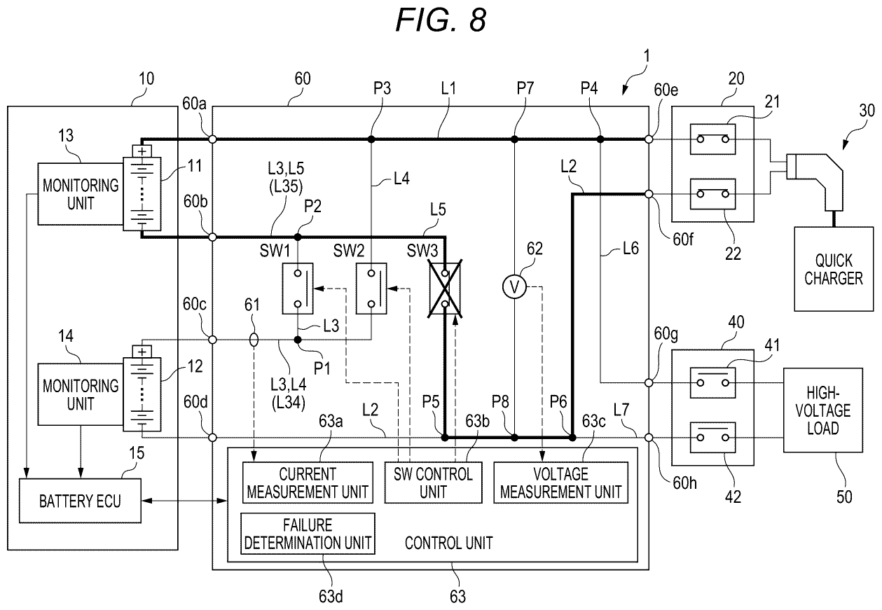

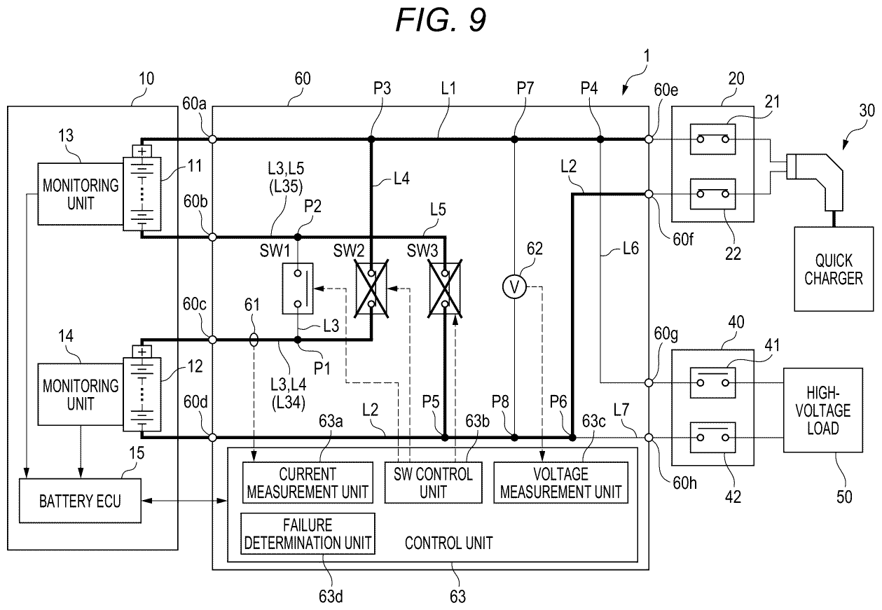

Therefore, the failure determination unit 63d identifies the location of the failure based on the current measured by the current measurement unit 63a. Here, the current sensor 61 can measure the current in the fourth line L4. Thus, as shown in FIG. 5, when a current larger than the normal current (the current at the time of parallel connection) is detected by the current measurement unit 63a, the failure determination unit 63d can determine that the second switch SW2 has an ON failure (see FIGS. 5 and 7). When no current is detected by the current measurement unit 63a (when the measured value is 0 A), the failure determination unit 63d can determine that the third switch SW3 has an ON failure (see FIGS. 5 and 8). Further, when the current measurement unit 63a detects the same current as in the normal state, the failure determination unit 63d can determine that both the second switch SW2 and the third switch SW3 have an ON failure (see FIGS. 5 and 9).

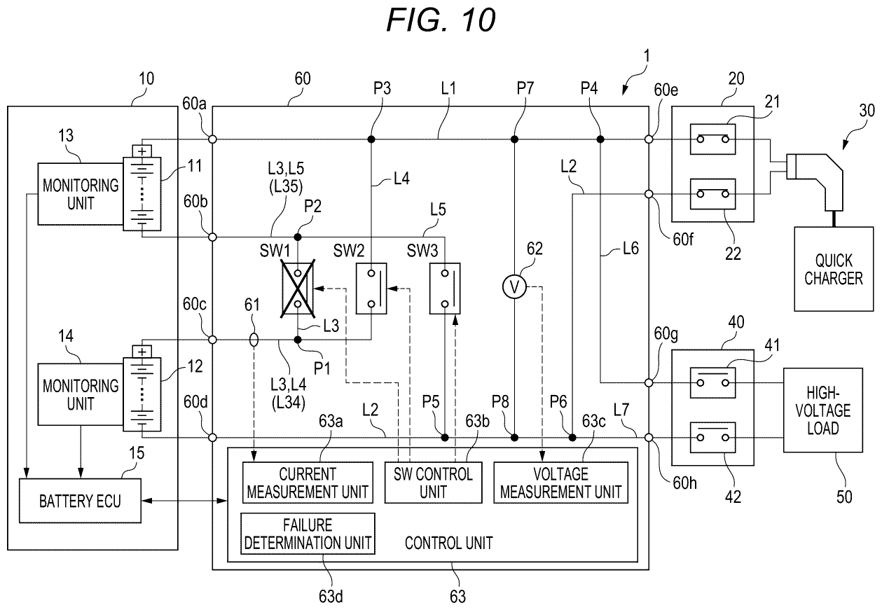

Refer again to FIG. 4. When all the switches SW1 to SW3 are shifted from the off state to the series state, the SW control unit 63b turns on the first switch SW1 as shown in FIG. 2. The SW control unit 63b keeps the second switch SW2 and the third switch SW3 off. In this case, the voltage measurement unit 63c is to measure the sum value of the voltage of the first battery 11 and the voltage of the second battery 12 (for example, to measure 800 V). Thus, when the sum value is measured by the voltage measurement unit 63c, the failure determination unit 63d can determine that the first switch SW1, the second switch SW2, and the third switch SW3 are normal (see FIGS. 2 and 4). In particular, since the first switch SW1 is turned on, the failure determination unit 63d can determine that the first switch SW1 does not have an OFF failure. On the other hand, when 0 V is measured by the voltage measurement unit 63c, it can be said that the first switch SW1 is not turned on although the SW control unit 63b executes the control of turning on the first switch SW1 (see FIGS. 4 and 10). Accordingly, the failure determination unit 63d determines that the first switch SW1 has an OFF failure.

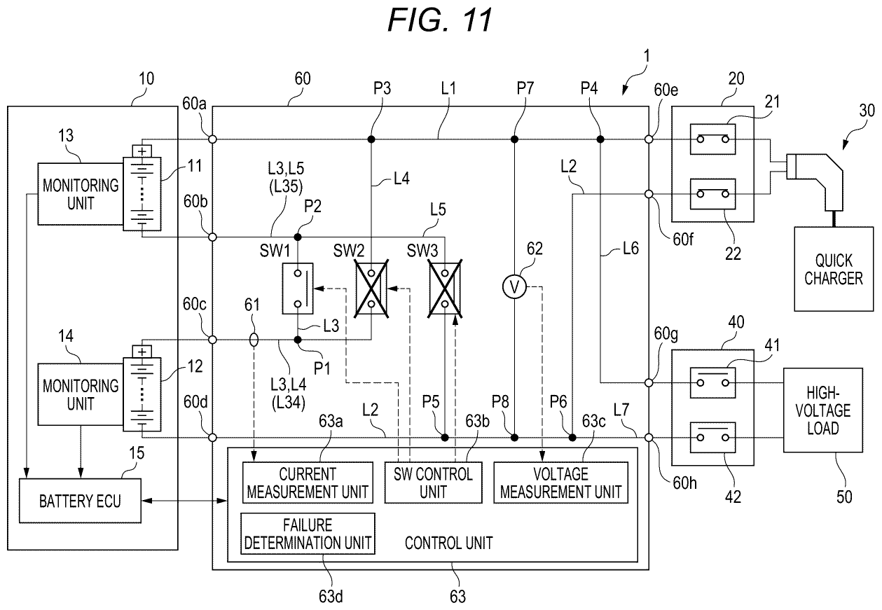

When all the switches SW1 to SW3 are shifted from the off state to the parallel state, the SW control unit 63b turns on the second switch SW2 and the third switch SW3 as shown in FIG. 3. The SW control unit 63b keeps the first switch SW1 off. In this case, the voltage measurement unit 63c is to measure a voltage of, for example, 400 V by turning on the second switch SW2 and the third switch SW3. Thus, when 0 V is measured by the voltage measurement unit 63c, the failure determination unit 63d can determine that both the second switch SW2 and the third switch SW3 have an OFF failure (see FIGS. 4 and 11). When the voltage of the first battery 11 and the voltage of the second battery 12 are the same or the like, even if 400 V, which is one of the voltages, is measured, both the second switch SW2 and the third switch SW3 may be normal. Further, either one of the second switch SW2 and the third switch SW3 may also have an OFF failure.

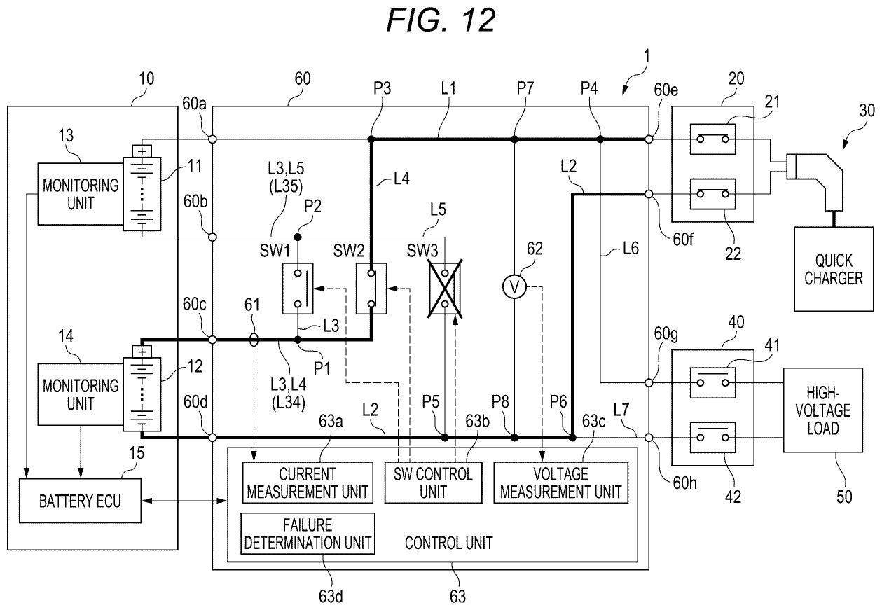

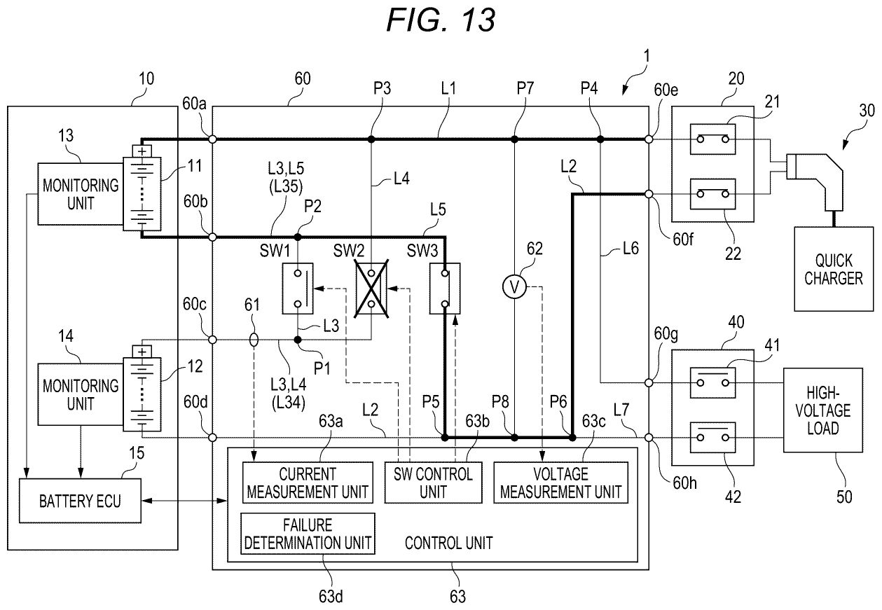

Therefore, the failure determination unit 63d identifies the location of the failure based on the current measured by the current measurement unit 63a. Here, the current sensor 61 can measure the current in the fourth line L4. Thus, as shown in FIG. 5, when a current larger than the normal current (the current at the time of parallel connection) is detected by the current measurement unit 63a, the failure determination unit 63d can determine that the third switch SW3 has an OFF failure (see FIGS. 5 and 12). When no current is detected by the current measurement unit 63a (when the measured value is 0 A), the failure determination unit 63d can determine that the second switch SW2 has an OFF failure (see FIGS. 5 and 13). Further, when the current measurement unit 63a detects the same current as in the normal state, the failure determination unit 63d can determine that both the second switch SW2 and the third switch SW3 are normal (see FIGS. 3 and 5).

In the present embodiment, the current sensor 61 can measure the current in the common portion L34 of the fourth line L4 with the third line L3. Therefore, for example, the failure determination unit 63d may determine whether the current is measured by the current measurement unit 63a in order to improve the accuracy of determining an ON failure when the first switch SW1 has an ON failure as shown in FIG. 6.

In this manner, according to the power distribution device 60 in the present embodiment, the voltage of the first line L1, the voltage of the second line L2, and the current in the fourth line L4 are measured, and the failure in the first switch SW1, the second switch SW2, or the third switch SW3 is determined. Here, an ON failure in which the first switch SW1, the second switch SW2, and the third switch SW3 are always on and an OFF failure in which the first switch SW1, the second switch SW2, and the third switch SW3 are always off may occur. When an ON failure or an OFF failure occurs in these switches SW1 to SW3, the location of the failure can be identified to some extent based on the voltage. However, it may be particularly difficult to determine which of the second switch SW2 or the third switch SW3 used at the time of parallel connection has a failure based only on the voltage. Therefore, the control unit 63 can determine which of the second switch SW2 or the third switch SW3 has a failure by further measuring the current in the fourth line L4. Therefore, when the plurality of switches SW1 to SW3 are provided for the batteries 11 and 12 to switch between the series connection and the parallel connection, it is possible to provide the power distribution device 60 capable of identifying the failed switches SW1 to SW3 to further improve the reliability.

Since the current measurement unit 63a measures the current of the common portion L34 of the fourth line L4 with the third line L3, the current in the third line L3 can also be measured, and the accuracy of failure determination can be improved.

Although the present invention is described above based on the embodiment, the present invention is not limited to the above embodiment, a modification may be made without departing from the gist of the present invention, and the known or well-known technique may be combined.

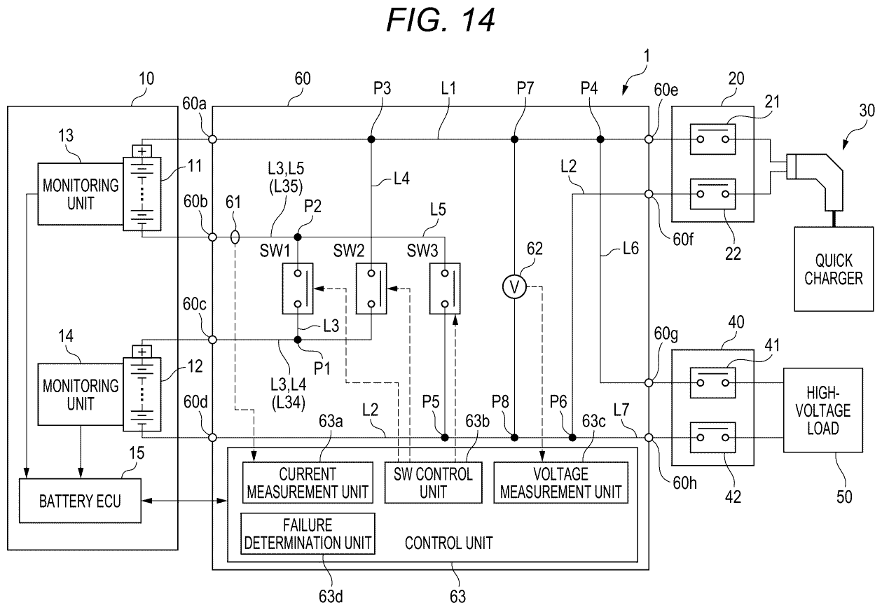

FIG. 14 is a configuration diagram showing the secondary battery system 1 according to a first modification of the present embodiment. As shown in FIG. 14, the current sensor 61 may be provided in the fifth line L5, and the current measurement unit 63a may measure the current in the fifth line L5. In this case, the failure determination unit 63d determines a failure by reversing “current detected (higher than normal)” and “no current” shown in FIG. 5. For example, it is assumed that all the switches SW1 to SW3 are off, and the failure determination result based on the voltage value indicates that the second switch SW2 or the third switch SW3 has an OFF failure. In this case, when a current larger than normal is detected by the current measurement unit 63a, the failure determination unit 63d determines that the third switch SW3 has an ON failure. On the other hand, when the current is not detected by the current measurement unit 63a, the failure determination unit 63d determines that the second switch SW2 has an ON failure. The same applies to the case in which the first switch SW1 is off and the second switch SW2 and the third switch SW3 are on.

In this case, the current sensor 61 is preferably provided in the common portion L35 of the fifth line L5 with the third line L3, and the current measurement unit 63a preferably measures the current in the common portion L35. This is because, in this case, the current in the third line L3 can also be measured, and the accuracy of failure determination can also be improved.

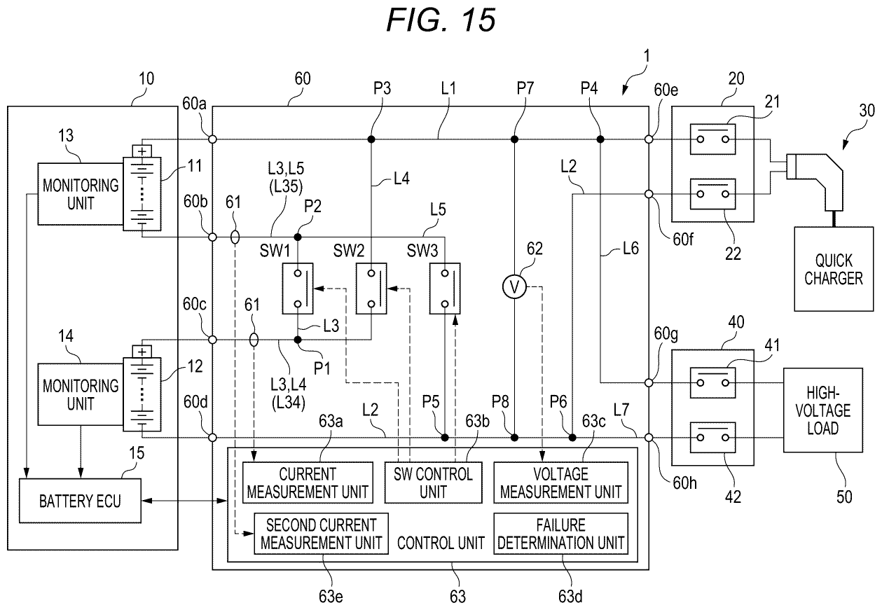

FIG. 15 is a configuration diagram showing the secondary battery system 1 according to a second modification of the present embodiment. As shown in FIG. 15, the current sensor 61 may be provided in both the fourth line L4 (particularly, the common portion L34) and the fifth line L5 (particularly, the common portion L35). In this case, the control unit 63 further includes a second current measurement unit 63e. In this case, the current measurement unit 63a measures the current in one of the fourth line L4 and the fifth line L5, and the second current measurement unit 63e measures the current in the other of the fourth line L4 and the fifth line L5. The failure determination unit 63d determines a failure in the first switch SW1, the second switch SW2, and the third switch SW3 based on the current measured by the second current measurement unit 63e in addition to the measurement results of the voltage measurement unit 63c and the current measurement unit 63a. According to the second modification, one of the second switch SW2 or the third switch SW3 that is not energized at the time of ON can be determined to have an OFF failure, and one of the second switch SW2 or the third switch SW3 that is energized at the time of off can be determined to have an ON failure.

What is claimed is:

1. A power distribution device comprising:
a first battery positive electrode terminal and a first battery negative electrode terminal connected to a positive electrode and a negative electrode of a first battery respectively;
a second battery positive electrode terminal and a second battery negative electrode terminal connected to a positive electrode and a negative electrode of a second battery respectively;
a charger positive electrode terminal and a charger negative electrode terminal connected to a positive electrode and a negative electrode of a charger respectively;
a first line connecting the first battery positive electrode terminal and the charger positive electrode terminal;
a second line connecting the second battery negative electrode terminal and the charger negative electrode terminal;
a third line connecting the second battery positive electrode terminal and the first battery negative electrode terminal;
a first switch configured to control conduction and interruption of the third line;
a fourth line connecting the second battery positive electrode terminal and the first line;
a second switch configured to control conduction and interruption of the fourth line;
a fifth line connecting the second line and the first battery negative electrode terminal;
a third switch configured to control conduction and interruption of the fifth line; and
a control unit configured to control conductive states and interruption states of the first switch, the second switch, or the third switch,
wherein the control unit includes
a voltage measurement unit configured to measure a voltage of the first line and the second line,
a current measurement unit configured to measure a current in one of the fourth line or the fifth line, and
a failure determination unit configured to determine a failure in the first switch, the second switch, or the third switch based on the voltage measured by the voltage measurement unit and the current measured by the current measurement unit.

2. The power distribution device according to claim 1,
wherein the control unit further includes a second current measurement unit configured to measure a current in another one of the fourth line or the fifth line, and
wherein the failure determination unit further determines a failure in the first switch, the second switch, or the third switch based on the current measured by the second current measurement unit.

3. The power distribution device according to claim 1,
wherein one end of the fourth line has a common portion shared with the third line and is connected to the second battery positive electrode terminal, and
wherein the current measurement unit measures a current in the fourth line and measures a current in the common portion with the third line.

4. The power distribution device according to claim 1,
wherein one end side of the fifth line has a common portion shared with the third line and is connected to the first battery negative electrode terminal, and
wherein the current measurement unit measures a current in the fifth line and measures a current in the common portion with the third line.

5. A power distribution device comprising:
a first battery positive electrode terminal and a first battery negative electrode terminal connected to a positive electrode and a negative electrode of a first battery respectively;
a second battery positive electrode terminal and a second battery negative electrode terminal connected to a positive electrode and a negative electrode of a second battery respectively;
a charger positive electrode terminal and a charger negative electrode terminal connected to a positive electrode and a negative electrode of a charger respectively;
a first line connecting the first battery positive electrode terminal and the charger positive electrode terminal;
a second line connecting the second battery negative electrode terminal and the charger negative electrode terminal;
a third line connecting the second battery positive electrode terminal and the first battery negative electrode terminal;
a first switch configured to control conduction and interruption of the third line;
a fourth line connecting the second battery positive electrode terminal and the first line;
a second switch configured to control conduction and interruption of the fourth line;
a fifth line connecting the second line and the first battery negative electrode terminal;
a third switch configured to control conduction and interruption of the fifth line;
a memory storing instructions; and
a processor configured to control conductive states and interruption states of the first switch, the second switch, or the third switch,
wherein the processor is configured to implement the instructions to:
measure a voltage between the first line and the second line,
measure a current in one of the fourth line or the fifth line, and
determine a failure in the first switch, the second switch, or the third switch based on the measured voltage and the measured current.
